(19) United States
(12) Patent Application Publication
(10) Pub. No.: US 2002/0170340 A1
(43) Pub. Date: Nov. 21, 2002

(54) Chamber for a high vacuum system

(76) Inventors: Bruse Lee, Pingtung (TW); Ching Shun Fan, Hsinchu Hsien (TW); Thanku Shieh, Kaohsiung Hsien (TW); Hsien Hsiang Lin, Kaohsiung Hsien (TW)

Correspondence Address: OPPENHEIMER WOLFF & DONNELLY, P. O. BOX 10356, PALO ALTO, CA, 94303, US

(21) Appl. No.: 09/921,261

(22) Filed: Aug. 1, 2001

(30) Foreign Application Priority Data
May 15, 2001 (TW) 90207911

(51) Int. Cl. G01M 3/04

(52) U.S. Cl. 73/49.2

(57) ABSTRACT

A chamber for a high vacuum system is provided. The chamber is tested by a leakage tester, and comprises a body and an intermediate unit. The body is provided with at least one port. The intermediate unit, disposed on the body, connects with the port in order to communicate with the leakage tester. When the chamber is to be tested by the leakage tester, it can be directly connected with the leakage tester through the intermediate unit. Leakage testing of the chamber is thus simplified and rendered considerably more efficient.

### BACKGROUND OF THE INVENTION

1. Field of the Invention

The invention relates to a chamber for a high vacuum system; in particular, the invention relates to a chamber that can be readily tested.

2. Description of the Related Art

FIG. 1 shows a high vacuum system 10. It comprises several process chambers 2 for processing required steps, for example, evaporation and deposition.

A dry pump 1 connects with a vacuum pipe 4. The other end of the vacuum pipe 4 connects with a first pipe 6 through a connector 5. The other end of the first pipe 6 connects with several third pipes 8 through a second pipe 7. Each third pipe 8, provided with a valve 3 thereon, communicates with one process chamber 2.

Since the vacuum state of the process chamber 2 is often compromised, the pressure of the high vacuum system 10 is unstable and its yield is frequently affected. Therefore, the vacuum state of the process chamber 2 must be tested by a leakage tester 11, such as a He leakage tester. The leakage tester 11 connects with the high vacuum system 10 through a serpentine pipe 12.

The leakage test of the high vacuum system 10 is conducted as follows. First, the dry pump 1 is closed. Then, after the first pipe 6 separates from the connector 5 along with the vacuum pipe 4, it connects with the serpentine pipe 12 of the leakage tester 11. Finally, after the valve 3 is closed, the leakage test begins.

The disadvantages of the leakage test of the conventional leakage vacuum system 10 are described as follows.

1. The dry pump 1 must be closed, and the alarm of the entire high vacuum system 10 is thus triggered.

2. When one of the process chambers 2 is tested, the dry pump 1 must be closed, disabling all of the process chambers 2. Thus, the run rate of the whole high vacuum system 10 is impacted.

3. The serpentine pipe 12, the first pipe 6, the second pipe 7 and the third pipe 8 all separate the leakage tester 11 and the process chamber 2. The length of the tested path is thus too long to accurately judge the vacuum state of the process chamber 2.

4. Test procedures, which include disassembling the vacuum pipe 4 and the connector 5, and connecting the first pipe 6 with the serpentine pipe 12 of the leakage tester 11, are overly troublesome.

### SUMMARY OF THE INVENTION

In order to address the disadvantages of the aforementioned conventional process chamber, the invention provides a chamber that can be readily tested.

Accordingly, the invention provides a chamber for a high vacuum system, wherein the chamber is tested by a leakage tester, comprising a body and an intermediate unit. The body is provided with at least one port. The intermediate unit, disposed on the body, connects with the port in order to communicate with the leakage tester.

Furthermore, the intermediate unit comprises a conduit and a one-way valve. The conduit, connected to the port, receives fluid from the chamber and communicates with the leakage tester. The one-way valve, disposed on the conduit, ensures that the fluid inside the conduit flows in a predetermined direction.

Furthermore, the intermediate unit further comprises a first seal member and a second seal member. The first seal member is disposed between the conduit and the port, and the second seal member is disposed between the conduit and the leakage tester.

Furthermore, the one-way valve is a manual valve.

### BRIEF DESCRIPTION OF THE DRAWINGS

The invention is hereinafter described in detail with reference to the accompanying drawings in which:

FIG. 1 is a schematic view depicting a conventional process chamber of a high vacuum system;

FIG. 2 is a schematic view depicting a process chamber of a high vacuum system of this invention;

FIG. 3 is a schematic view depicting an intermediate unit of this invention;

FIG. 4a is a perspective view depicting the intermediate unit of this invention from the view of the chamber side;

FIG. 4b is a side view depicting the intermediate unit of this invention at the chamber side; and

FIG. 5 is a perspective view depicting the intermediate unit of this invention from the view of the tested side.

### DETAILED DESCRIPTION OF THE INVENTION

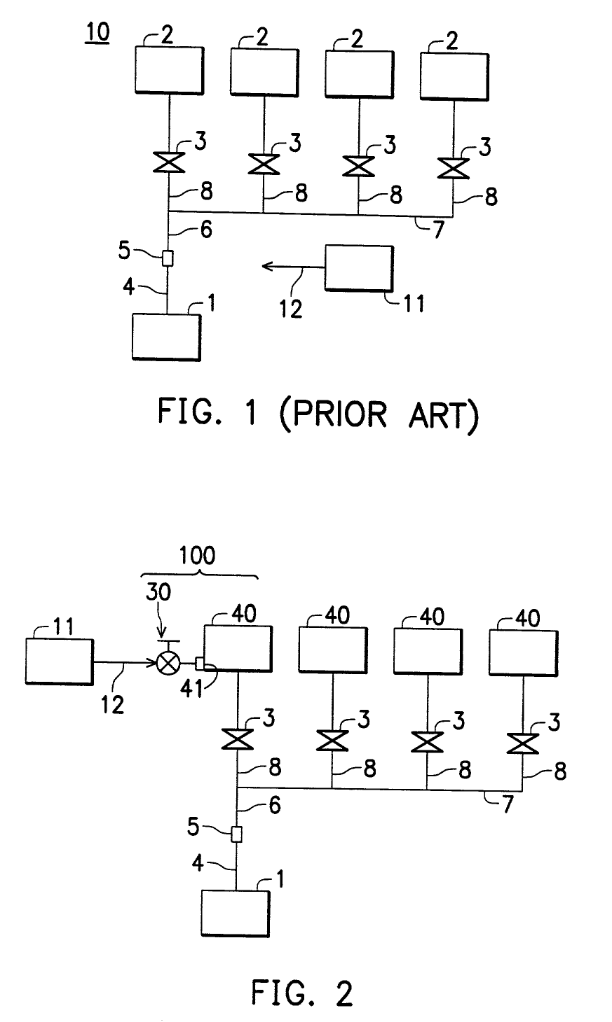

Referring to FIG. 2, a chamber 100 of this invention is adapted to a high vacuum system 10 as shown in FIG. 1. A dry pump 1, valves 3, a vacuum pipe 4, a connector 5, a first pipe 6, a second pipe 7 and third pipes 8, as shown in FIG. 2, are the same with the units as shown in FIG. 1; therefore, their description is omitted.

The chamber 100 comprises a body 40 and an intermediate unit 30. By means of the intermediate unit 30, the chamber 100 can directly communicate with a serpentine pipe 12 of a leakage tester 11.

Although each body 40 is provided with several ports 41, it is noted that only one port 41 is shown in FIG. 2. The port 41 is used to connect with the intermediate unit 30. It is noted that the conventional process chamber 2 is also provided with ports. However, ports in the conventional chamber are used in a different way, or are not used.

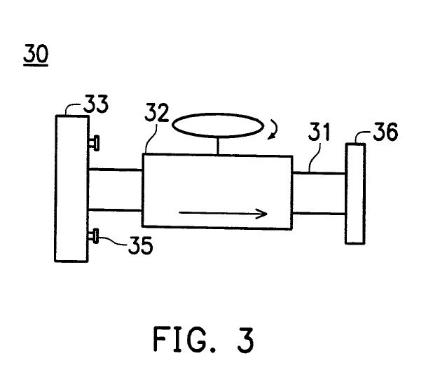

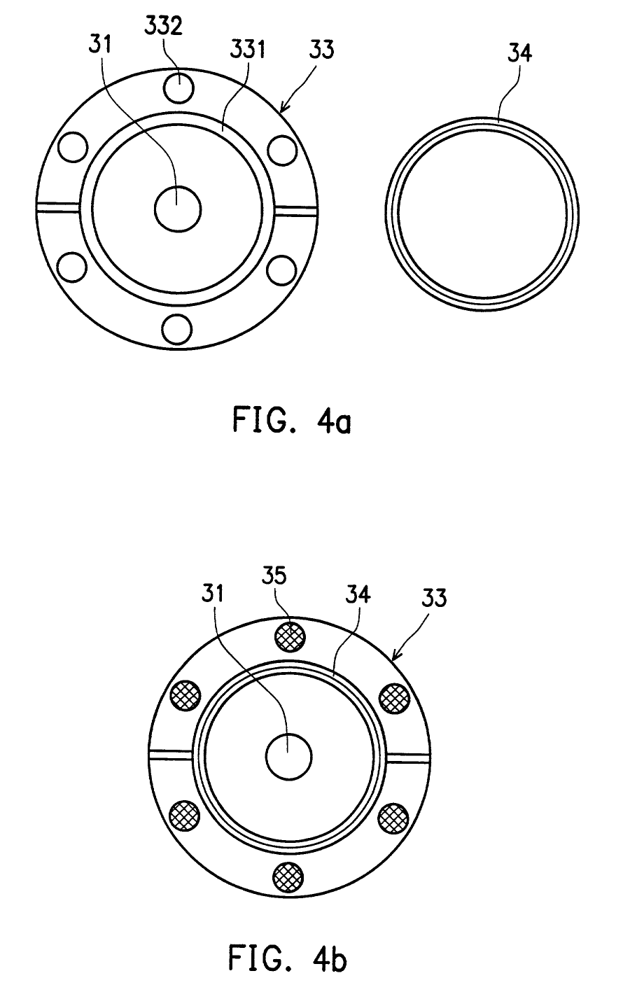

Referring to FIG. 3, the intermediate unit 30 comprises a conduit 31 and a one-way valve 32. The one-way valve 32 is disposed on the conduit 31 and ensures that the fluid inside the conduit flows in a predetermined direction. The conduit 31 is provided with a first flange 33 and a second flange 36 at both ends. The intermediate unit 30 further comprises several screws 35 and a clamping member 38. There are six screws 35 shown in FIG. 4b. The first flange 33 of the conduit 31 connects with the body 40 by the screws 35, and the second flange 36 of the conduit 31 connects with the leakage tester 11 by the clamping member 38.

Referring to FIG. 4a and FIG. 4b, the intermediate unit 30, viewed from the chamber 40, is shown. The first flange 33 is provided with a first slot 331 and several through holes 332. There are six through holes 332 shown in FIG. 4a. A first seal member 34 is disposed inside the first slot 331. After the screws 35 screw into the screw holes (not shown) of the chamber 100 through the through holes 332, the intermediate unit 30 is attached to the process chamber 100.

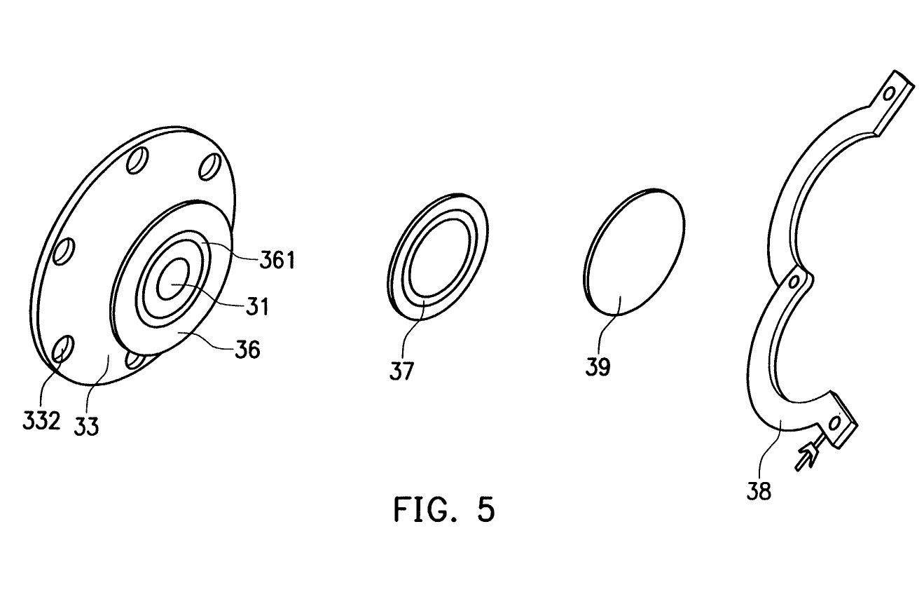

Referring to FIG. 5, the second flange 36 is provided with a second slot 361. A second seal member 37 is disposed inside the second slot 361. The intermediate unit 30 connects with the serpentine pipe 12 of the leakage tester 11 by the clamping member 38.

By disposing the first seal member 34 between the conduit 31 of the intermediate unit 30 and the port 41 of the chamber 100, and disposing the second seal member 37 between the conduit 31 of the intermediate unit 30 and the leakage tester 11, the seal state between the chamber 100 and the leakage tester 11 is assured.

Furthermore, the intermediate unit 30 further comprises a plate 39. When the chamber 100 is not tested by the leakage tester 11, the plate 39 covers the side, facing the leakage tester 11, of the intermediate unit 30 by the clamping member 38.

Furthermore, the one-way valve 32 is preferably a manual valve.

In the above structure, when the chamber 100 is to be tested by the leakage tester 11, it can be directly connected with the serpentine pipe 12, as shown in FIG. 2. Then, after the one-way valve 32 of the intermediate unit 30 is open, the leakage tester can proceed.

The advantages of the chamber of this invention are described as follows:

1. Since each chamber is connected to the leakage tester independently, only one specified valve, connected to the chamber to be tested, is closed. Therefore, the dry pump need not be closed thus preventing triggering of the alarm of the entire high vacuum system.

2. When one of the process chambers is tested, the dry pump need not be closed, and thus other process chambers can still proceed. Thus, the run rate of the whole high vacuum system increases.

3. Only one serpentine pipe connects the leakage tester and the process chamber, therefore reducing the length of the tested path so that the vacuum state of the process chamber can be accurately judged.

4. The chamber can be directly connected with the serpentine pipe of the leakage tester via the intermediate unit, thereby simplifying the assembly process.

While the invention has been particularly shown and described with reference to a preferred embodiment, it will be readily appreciated by those of ordinary skill in the art that various changes and modifications may be made without departing from the spirit and scope of the invention. It is intended that the claims be interpreted to cover the disclosed embodiment, those alternatives which have been discussed above, and all equivalents thereto.

What is claimed is:

1. A chamber for a high vacuum system, wherein the chamber is tested by a leakage tester, comprises:
a body provided with at least one port; and
an intermediate unit, disposed on the body, connecting with the port in order to communicate with the leakage tester.

2. The chamber as claimed in claim 1, wherein the intermediate unit comprises:
a conduit, connected with the port, receiving fluid from the chamber and communicating with the leakage tester; and
a one-way valve, disposed on the conduit, ensuring that the fluid inside the conduit flows in a predetermined direction.

3. The chamber as claimed in claim 2, wherein the intermediate unit further comprises:
a first seal member disposed between the conduit and the port; and
a second seal member disposed between the conduit and the leakage tester.

4. The chamber as claimed in claim 2, wherein the one-way valve is a manual valve.
